(19) United States
(12) Patent Application Publication
(10) Pub. No.: US 2024/0378620 A1
(43) Pub. Date: Nov. 14, 2024

(54) DATA RESOURCE RESTRICTION AND ENFORCEMENT ENGINE

(71) Applicant: Robert Chase Harmer, Reno, NV (US)

(72) Inventor: Robert Chase Harmer, Reno, NV (US)

(21) Appl. No.: 18/661,529

(22) Filed: May 10, 2024

Related U.S. Application Data
(60) Provisional application No. 63/465,955, filed on May 12, 2023.

(51) Int. Cl. G06Q 20/40

(52) U.S. Cl. CPC G06Q 20/405; G06Q 20/4016

(57) ABSTRACT

An online platform may receive a usage restriction from an originator. The platform may create a collection event for a transferee to collect fungible data increments from originators. The platform may create a transaction account issued to the transferee. The platform may maintain a first browsing session between the online platform and a client device. An online platform may cause to launch a second browsing session between the client device and a third-party platform. The platform may track an action of the transferee associated with the collected fungible data increments performed at the second browsing session. The platform may receive, from the third-party platform, a data payload comprising information indicating an attempt by the transferee to further transfer at least a portion of the collected fungible data increments to the third-party platform and apply the usage restriction to the information to determine whether the attempt violates the usage restriction.

### FIELD

This disclosure relates generally to managing and restricting the usage of fungible data increments.

### BACKGROUND

In the digital data world, some resources are fungible and often, due to the fungible nature, do not have an association with a particular increment of the resources with an originator. As such, downstream enforcement of the usage and restriction of fungible resources can be difficult. The difficulties in enforcing restrictions on fungible resources, particularly in digital data contexts, stem from their inherent interchangeability and lack of distinct individual identity. Once these resources are commingled with others, the resources may lose any direct association with their originator, rendering it challenging to trace and monitor their subsequent use. Unlike non-fungible resources, which retain unique identifiers or characteristics facilitating origin tracking, fungible resources lack such discernible markers. Consequently, enforcing limitations imposed by the originator becomes a formidable challenge in downstream scenarios.

The blending of fungible resources with a larger pool further compounds the enforcement dilemma, as their integration dilutes any discernible traces of their original ownership. Consequently, distinguishing and isolating specific increments of these resources for enforcement purposes becomes increasingly complex. This inherent indistinguishability inherent to fungible resources presents a significant hurdle in implementing and upholding restrictions imposed by the originator, undermining the efficacy of conventional enforcement mechanisms in digital environments.

### SUMMARY

In some embodiments, the disclosure described herein relate to a computer-implemented method, including: receiving a usage restriction from an originator related to a usage of a fungible data increment associated with the originator; creating, by an online platform, a collection event for a transferee to collect a plurality of fungible data increments from a plurality of originators, wherein collected fungible data increments in the collection event are subject to the usage restriction; responsive to the collection event collecting the plurality of fungible data increments for the transferee, creating a transaction account issued to the transferee, the transaction account for tracking use of the collected fungible data increments; maintaining a first browsing session between the online platform and a client device of the transferee; causing to launch, from the first browsing session, a second browsing session between the client device and a third-party platform; tracking an action of the transferee associated with the collected fungible data increments performed at the second browsing session, wherein tracking the action of the transferee includes: receiving, from the third-party platform, a data payload including information indicating an attempt by the transferee to further transfer at least a portion of the collected fungible data increments to the third-party platform; and applying the usage restriction to the information to determine whether the attempt violates the usage restriction; and responsive to determining that the attempt is in compliant with the usage restriction, approving the transaction account to complete the attempt.

In some embodiments, the disclosure described herein relates to a computer-implemented method, wherein creating the collection event for the transferee includes: allowing the transferee to describe a story of the collection event in natural language; applying a transformer machine-learned model to identify one or more usage restrictions based on the story in natural language; and generating the usage restriction associated with the collection event.

In some embodiments, the disclosure described herein relates to a computer-implemented method, wherein receiving the usage restriction from the originator related to the usage of the fungible data increment associated with the originator includes: receiving, from the transferee, an association between the usage restriction and the collection event; receiving a donation from the originator to donate the fungible data increment to the collect event; and applying the usage restriction to future usages of the fungible data increment.

In some embodiments, the disclosure described herein relates to a computer-implemented method, wherein creating a transaction account issued to the transferee includes: associating the transaction account to a third-party named entity category; and restricting transactions of the transaction account to the third-party named entity category, wherein the third-party named entity category is associated with the usage restriction.

In some embodiments, the disclosure described herein relates to a computer-implemented method, wherein maintaining the first browsing session between the online platform and the client device of the transferee includes: providing, in the first browsing session, a plurality of options of third-party platforms for a selection of the transferee; receiving the selection from the transferee selecting the third-party platform; and responsive to the selection, causing the second browsing session to launch.

In some embodiments, the disclosure described herein relates to a computer-implemented method, wherein causing the launch of the second browsing session between the client device and the third-party platform includes: creating a session identifier for the online platform to track the second browsing session; and generating a uniform resource locator that contains a domain name of the third-party platform and the session identifier, wherein the uniform resource locator launches the second browsing session.

In some embodiments, the disclosure described herein relates to a computer-implemented method, wherein tracking the action of the transferee further includes: receiving, in the data payload, a list of items selected by the transferee in the second browsing session; and applying the usage restriction to the list of items to determine whether the attempt violates the usage restriction.

In some embodiments, the disclosure described herein relates to a computer-implemented method, wherein applying the usage restriction to the information to determine whether the attempt violates the usage restriction includes: inputting at least a portion of the data payload to a machine-learned model; receiving an output of the machine-learned model that analyzes the portion of the data payload based on the usage restriction; and determining whether the attempt violates the usage restriction based on the output.

In some embodiments, the disclosure described herein relates to a computer-implemented method, wherein training of the machine-learned model includes: receiving a plurality of training samples, each training sample including (1) a label of whether a historical transaction is compliant with a historical usage restriction and (2) a feature vector of the historical transactions; initiating a plurality of parameters associated with the machine-learned model; generating, in a forward propagation using feature vectors of the training samples, a plurality of predictions of compliance; comparing the plurality of predictions of compliance to labels of the training samples; and backpropagating comparisons between the plurality of predictions and the labels to the parameters to adjust values of the parameters.

In some embodiments, the disclosure described herein relates to a computer-implemented method, further including generating an analytics report to the originator on the usage of the fungible data increment; receiving a report from the originator on a potential violation of the usage restriction; and responsive to the report, adjusting a usage privilege of the transaction account.

In some embodiments, the disclosure described herein relate to a non-transitory computer-readable medium configured to store code including instructions, wherein the instructions, when executed by one or more processors, cause the one or more processors to: receive a usage restriction from an originator related to a usage of a fungible data increment associated with the originator; create, by an online platform, a collection event for a transferee to collect a plurality of fungible data increments from a plurality of originators, wherein collected fungible data increments in the collection event are subject to the usage restriction; responsive to the collection event collecting the plurality of fungible data increments for the transferee, create a transaction account issued to the transferee, the transaction account for tracking use of the collected fungible data increments; maintain a first browsing session between the online platform and a client device of the transferee; cause to launch, from the first browsing session, a second browsing session between the client device and a third-party platform; track an action of the transferee associated with the collected fungible data increments performed at the second browsing session, wherein the instructions to track the action of the transferee include instructions to: receive, from the third-party platform, a data payload including information indicating an attempt by the transferee to further transfer at least a portion of the collected fungible data increments to the third-party platform; and apply the usage restriction to the information to determine whether the attempt violates the usage restriction; and responsive to determining that the attempt is in compliant with the usage restriction, approve the transaction account to complete the attempt.

In some embodiments, the disclosure described herein relates to a non-transitory computer-readable medium, wherein the instructions to create the collection event for the transferee include instructions to: allow the transferee to describe a story of the collection event in natural language; apply a transformer machine-learned model to identify one or more usage restrictions based on the story in natural language; and generate the usage restriction associated with the collection event.

In some embodiments, the disclosure described herein relates to a non-transitory computer-readable medium, wherein the instructions to receive the usage restriction from the originator related to the usage of the fungible data increment associated with the originator include instructions to receive, from the transferee, an association between the usage restriction and the collection event; receive a donation from the originator to donate the fungible data increment to the collect event; and apply the usage restriction to future usages of the fungible data increment.

In some embodiments, the disclosure described herein relates to a non-transitory computer-readable medium, wherein the instructions to create a transaction account issued to the transferee include instructions to: associate the transaction account to a third-party named entity category; and restrict transactions of the transaction account to the third-party named entity category, wherein the third-party named entity category is associated with the usage restriction.

In some embodiments, the disclosure described herein relates to a non-transitory computer-readable medium, wherein the instructions to maintain the first browsing session between the online platform and the client device of the transferee include instructions to: provide, in the first browsing session, a plurality of options of third-party platforms for a selection of the transferee; receive the selection from the transferee selecting the third-party platform; and responsive to the selection, cause the second browsing session to launch.

In some embodiments, the disclosure described herein relates to a non-transitory computer-readable medium, wherein the instructions to launch the second browsing session between the client device and the third-party platform include instructions to: create a session identifier for the online platform to track the second browsing session; and generate a uniform resource locator that contains a domain name of the third-party platform and the session identifier, wherein the uniform resource locator launches the second browsing session.

In some embodiments, the disclosure described herein relates to a non-transitory computer-readable medium, wherein the instructions to track the action of the transferee further include instructions to receive, in the data payload, a list of items selected by the transferee in the second browsing session; and apply the usage restriction to the list of items to determine whether the attempt violates the usage restriction.

In some embodiments, the disclosure described herein relates to a non-transitory computer-readable medium, wherein the instructions to apply the usage restriction to the information to determine whether the attempt violates the usage restriction include instructions to: input at least a portion of the data payload to a machine-learned model; receive an output of the machine-learned model that analyzes the portion of the data payload based on the usage restriction; and determine whether the attempt violates the usage restriction based on the output.

In some embodiments, the disclosure described herein relates to a non-transitory computer-readable medium, wherein instructions to train the machine-learned model include instructions to: receive a plurality of training samples, each training sample including (1) a label of whether a historical transaction is in compliant with a historical usage restriction and (2) a feature vector of the historical transactions; initiate a plurality of parameters associated with the machine-learned model; generate, in a forward propagation using feature vectors of the training samples, a plurality of predictions of compliance; compare the plurality of predictions of compliance to labels of the training samples; and backpropagate comparisons between the plurality of predictions and the labels to the parameters to adjust values of the parameters.

In some embodiments, the disclosure described herein relate to a system including: one or more processors; and memory configured to store code including instructions, wherein the instructions, when executed by the one or more processors, cause the one or more processors to: receive a usage restriction from an originator related to a usage of a fungible data increment associated with the originator; create, by an online platform, a collection event for a transferee to collect a plurality of fungible data increments from a plurality of originators, wherein collected fungible data increments in the collection event are subject to the usage restriction; responsive to the collection event collecting the plurality of fungible data increments for the transferee, create a transaction account issued to the transferee, the transaction account for tracking use of the collected fungible data increments; maintain a first browsing session between the online platform and a client device of the transferee; cause to launch, from the first browsing session, a second browsing session between the client device and a third-party platform; track an action of the transferee associated with the collected fungible data increments performed at the second browsing session, wherein tracking the action of the transferee include instructions to: receive, from the third-party platform, a data payload including information indicating an attempt by the transferee to further transfer at least a portion of the collected fungible data increments to the third-party platform; and apply the usage restriction to the information to determine whether the attempt violates the usage restriction; and responsive to determining that the attempt is in compliant with the usage restriction, approve the transaction account to complete the attempt.

### BRIEF DESCRIPTION OF THE DRAWINGS

FIG. 1 is a block diagram of a system environment, in accordance with some embodiments.

FIG. 2 is a block diagram illustrating components of an online platform, in accordance with an embodiment.

FIG. 3 is a flowchart depicting an example process for enforcing usage restriction in a crowd-sourcing event, according to some embodiments.

FIGS. 4A and 4B are examples of block diagrams describing a process of a crowding sourcing event and enforcing the policy after a transaction account is issued to a beneficiary, in accordance with some embodiments.

FIG. 5 is a conceptual diagram illustrating a machine-learned model, in accordance with some embodiments.

The figures depict embodiments of the present disclosure for purposes of illustration only. Alternative embodiments of the structures and methods illustrated herein may be employed without departing from the principles, or benefits touted, by the disclosure described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

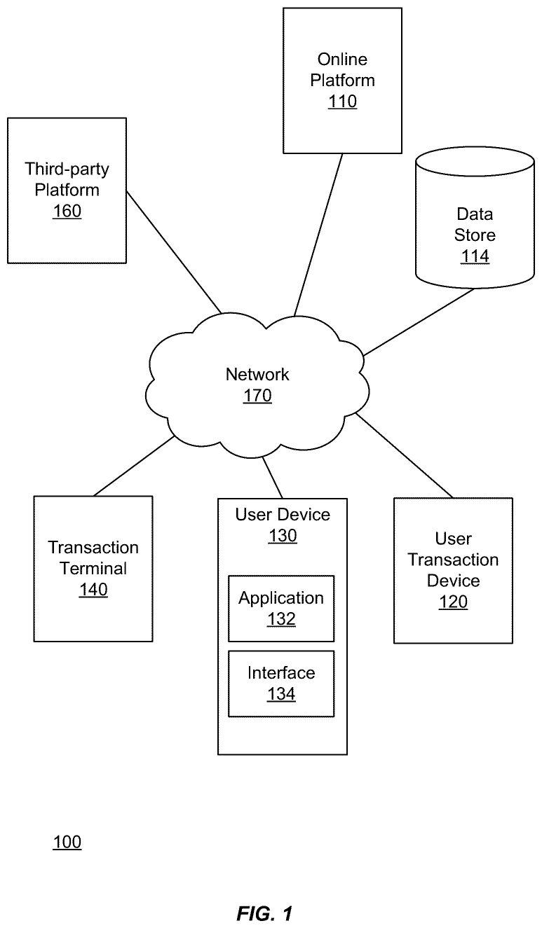

FIG. 1 is a block diagram of a system environment 100, in accordance with some embodiments. The online platform 110 includes one or more computers that perform various tasks related to managing resources and crowd-sourcing events, issuance of transaction accounts, and enforcement of usage policies on the transaction accounts, such as usage permissions and restrictions. In various embodiments, the online platform 110 may also be referred to as a policy compliance management server, an online server, a crowd source resource server, a resource management server, a first computing server, or simply a computing server. For example, the online platform 110 creates a transaction account such as a card, virtual or physical, based on a crowd-sourcing event to keep track of a user's use of the resources. The online platform 110 also enforces policies created by the crowd-sourcing event based on the usage of the resources. The policies may be determined by the crowd-sourcing event such as by the donors in the event on how the beneficiary may use the resources.

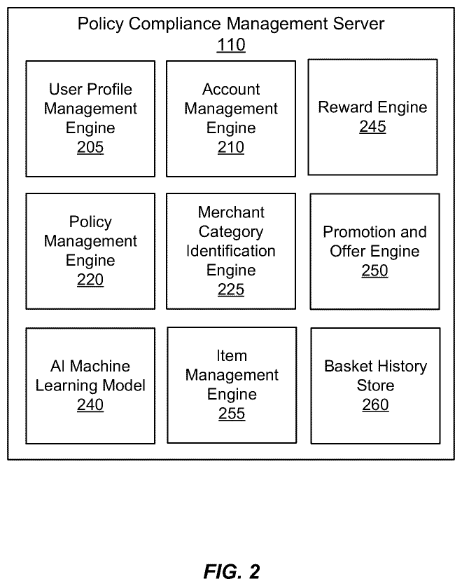

Policies may include pre-authorization and restrictions on certain transactions and categories. In some embodiments, the online platform 110 provides a platform for users to create the crowd-sourcing event to collect resources to a user's transaction account. In some embodiments, the online platform 110 receives the conditions of a completed crowd-sourcing event and enforces the policies in the crowd-sourcing event. Examples of components and functionalities of the online platform 110 are discussed in further detail below with reference to FIG. 2.

A crowd-sourcing event collects resources for a beneficiary to use from any participants who are willing to provide resources to the beneficiary. The participants who provide resources to the beneficiary may be referred to as originators or donors. The beneficiary who receives the resources may be referred to as a transferee. An originator may decide to transfer a resource, such as a data resource, to a transferee in a crowd-sourcing event but with one or more conditions on the usage of the resource. In some embodiments, the conditions may be set by the originator such as in situations where the originator only allows the resources to be used in a certain manner. In some embodiments, the conditions may be associated with crowd-sourcing events. For example, when a beneficiary transferee creates a crowd-sourcing event, the transferee may set forth the reasons for creating the event and the conditions associated with the events. In turn, any resources collected in the crowd-sourcing event may be subject to the conditions. A crowd-sourcing event may be created and carried out on the online platform 110, which may impose conditions on the resources collected.

In some embodiments, the resources collected in a crowd-sourcing event may be a type of data resource that may be referred to as a fungible data increment. In this disclosure, a fungible data increment may simply be referred to as a resource or a data resource. A data resource that is fungible may be interchangeable and indistinguishable from one another. A unit of a fungible resource may be replaced by another unit of the same type. Data increment may refer to the count of a fungible resource as the resource is collected in a crowd-sourcing event. For example, a first originator may provide a first quantity of fungible resources to the crowd-sourcing event. A second originator, unrelated to the first originator, may provide a second quantity of fungible resources to the crowd-sourcing event. The two quantities may be superimposed from the perspective of the transferee and not distinguishable. In some embodiments, the online platform 110 may increment in a transaction account of the transferee on the quantity of the fungible resource received by the transferee. Examples of fungible data increments may include memory allocation, allocated bandwidths, some forms of generic Cloud computing units, blockchain fungible tokens, rewards, transferrable coupons, digital forms of financial instruments, securities, and other data resources that can be incremented and transferred among various users. The fungible data increments may be stored in a ledger that records the quantity of the fungible data increments assigned to a transferee and how the transferee uses the fungible data increments. The ledger may be a blockchain ledger, an internal ledger used by the online platform 110, or any data accounting system.

Conventionally, since a fungible resource often may not be associated with specific metadata that can be tracked based on the originator, enforcement of the usage of the fungible resource may be difficult. This disclosure provides various examples of embodiments of how usage of a fungible resource may be restricted based on a policy set by the originator or set in the crowd-sourcing event.

The data store 114 may include various databases that store data related to third parties and data related to users. Each data store includes one or more computing devices that include memories or other storage media for storing various files and data of the online platform 110. The data stored in the data store 114 includes data accounting information, transaction data, user profiles, usage rules and restrictions, third-party categories such as merchant categories, usage records, and other related data associated with various clients of the online platform 110. The user data store may store data such as usage rewards, promotions, category specification information about resource balance, usage limits, and other information about the users, who can be originators and/or transferees.

In various embodiments, a data store may take different forms. In one embodiment, a data store is part of the online platform 110. For example, a data store is part of the local storage (e.g., hard drive, memory card, data server room) of the online platform 110. In some embodiments, a data store is a network-based storage server (e.g., a cloud server). A retailer data store may be a third-party storage system such as AMAZON AWS, DROPBOX, RACKSPACE CLOUD FILES, AZURE BLOB STORAGE, GOOGLE CLOUD STORAGE, etc. The data in a data store may be structured in different database formats such as a relational database using the structured query language (SQL) or other data structures such as a non-relational format, a key-value store, a graph structure, a linked list, an object storage, a resource description framework (RDF), etc. In one embodiment, the data store uses various data structures mentioned above. In some embodiments, the data store 114 may include a ledger of a transaction account associated with a transferee. The ledger may be used to track the quantity of a fungible data increment that is assigned to the transferee.

A user transaction device 120 is a device that enables the holder of the device 120 to perform a transaction with a party, such as transferring resources from a beneficiary of a crowd-sourcing event to a third party at a connected marketplace. A user transaction device 120 may use security chips and an application programming interface (API) to conduct a transaction with a third-party platform 160. Examples of user transaction devices 120 include portable electronic devices such as smartphones that enable resource transaction methods, wearable electronic devices, or a physical chip device. In some embodiments, a user transaction device 120 may display shopping carts and hosted pages. The user transaction device 120 may also be a mobile device such as a smartphone that includes a virtual card issued by the online platform 110. The online platform 110 issues transaction accounts and imposes usage control rules and restrictions on those accounts. While virtual transaction cards are sometimes used as examples in the discussion of this disclosure, various architectures and processes described herein may also be applied to other types of user transaction devices 120.

A client device 130 is a computing device that belongs to a user of the online platform 110. A user may be an originator who donates resources and transferees who receive resources. A user may also be simultaneously an originator and a transferee such as being a donor in one crowd-sourcing event and a beneficiary in another crowd-sourcing event. A user may use the client device 130 to communicate with the online platform 110 and perform various tasks, such as managing a user account, participating in a crowd-sourcing event as a donor, receiving fund event as a beneficiary, using transaction account to use resources in a marketplace, monitoring the spending of a crowding funding event, and monitoring transaction activities as a beneficiary. A client device 130 includes one or more applications 132 and an interface 114 that may display visual elements of the application 132. The client device 130 may be any computing device. Examples of such client devices 130 include personal computers (PC), desktop computers, laptop computers, tablets (e.g., iPADs), smartphones, wearable electronic devices such as smartwatches, or any other suitable electronic devices.

The application 132 is a software application that operates at the client device 130. A portal created by the online platform 110 may be an example of application 132. For example, one of the applications 132 is published by the party that operates the online platform 110 to allow clients to communicate with the online platform 110. An application 132 may be part of a platform of the online platform 110 that allows a crowd-sourcing event to be posted and allows users to log in to their accounts, whether they are donors or beneficiaries. In some embodiments, another application 132 may be an application of the third-party platform 160 for a user to use the resources. The online platform 110 may cooperate with a number of third-party platforms 160 so that users of the online platform 110 may use the resources under the condition of the crowd-sourcing event in various applications 132.

In some embodiments, applications 132 may be of different types. In one embodiment, application 132 is a web application that runs on JavaScript and other backend algorithms. In the case of a web application, the application 132 cooperates with a web browser to render a front-end interface 134. In another embodiment, an application 132 is a mobile application. For example, the mobile application may run on Swift for iOS and other APPLE operating systems or on Java or another suitable language for ANDROID systems. In yet another embodiment, application 132 may be a software program that operates on a desktop computer that runs on an operating system such as LINUX, MICROSOFT WINDOWS, MAC OS, or CHROME OS.

An interface 134 is a suitable interface for a client to interact with the online platform 110. The client may communicate with the application 132 and the online platform 110 through the interface 134. The interface 134 may take different forms. In one embodiment, the interface 134 may be a web application front-end component that is rendered in a web browser such as CHROME, FIREFOX, SAFARI, INTERNET EXPLORER, EDGE, etc. and the application 132 may be the web application that may also include the backend. In one embodiment, the interface 134 is part of the application 132. For example, the interface 134 may be the front-end component of a mobile application or a desktop application. In one embodiment, the interface 134 also is a graphical user interface (GUI) which includes graphical elements and user-friendly control elements. In one embodiment, the interface 134 does not include graphical elements but communicates with the data management server 120 via other suitable ways such as application program interfaces (APIs), which may include conventional APIs and other related mechanisms such as webhooks. In some embodiments, the interface 134 may be connected to a retailer marketplace, which may be maintained by the online platform 110.

A transaction terminal 140 is an interface that allows a user transaction device 120 to use resources with a third party. In some embodiments, resource usage may take the form of resource transfer in fund transfer, such as credit card transfer, automated teller machine (ATM) transfers, direct deposits, debits, online transfers, peer-to-peer transactions, instant-messaging fund transfers, wire transfers, electronic bill payment, automated clearing house (ACH) transfer, cryptocurrency transfer, blockchain transfer, etc. Depending on the type of resource usage, a transaction terminal 140 may take different forms. A transaction terminal 140 may be physical or virtual. For example, if the resource usage is physical usage, the transaction terminal 140 can be a physical device such as a point of sale (POS) terminal (e.g., a card terminal) or can be a website for online orders, hosted pages, or shopping carts. An ATM, a bank website, a peer-to-peer mobile application, and an instant messaging application can also be examples of a transaction terminal 140. In some embodiments, the resource usage may be conducted online and the transaction terminal 140 may be a checkout webpage session of a third-party platform 160. In a transaction of a resource, the transaction terminal 140 may generate a transaction data payload that carries information related to user transaction device 120, the third party, and the transaction. Data of a transaction may be hosted in the data store 114. At checkout, the system may itemize the selected basket and split the items chosen into categories. The online platform 110 may generate rewards in the form of additional fungible resource increments. The rewards may be provided to the beneficiary of a crowd-sourcing event and/or an originator of the event.

The online platform 110 may also include a server that manages the usage of resources based on one or more crowd-sourced policies associated with transaction accounts. For example, the online platform 110 may control card issuance and receive a transaction data payload from a transaction terminal 140 for a pending transaction. The online platform 110 may retrieve policies on the credit card from the online platform 110 and determine whether a transaction should be approved or denied based on the policies. For example, the policy may be a usage category restriction based on what has been agreed upon within the crowd-sourcing event. The category restriction may be enforced based on merchant category code (MCC) or other suitable ways. In some embodiments, the policy may also be analyzed and enforced by a machine-learned model based on further discussion below.

A third-party platform 160 may be a platform that allows users to use resources in exchange for items and services. For example, a beneficiary of a crowd-sourcing event may visit a third-party platform 160 and use the resources collected in the crowd-sourcing event. In some embodiments, the third-party platform 160 is operated by a third party that is not the same party as the operator of the online platform 110 but may enter agreements with the operator of the online platform 110. In some embodiments, the third-party platform 160 may control the transaction terminal 140 and transmit transaction payload data to the online platform 110 for the online platform 110 to determine whether to approve the transaction based on one or more policies set forth in a crowd-sourcing event.

Various servers in this disclosure may take different forms. In one embodiment, a server is a computer that executes code instructions to perform various processes described in this disclosure. In another embodiment, a server is a pool of computing devices that may be located at the same geographical location (e.g., a server room) or be distributed geographically (e.g., cloud computing, distributed computing, or in a virtual server network). In one embodiment, a server includes one or more virtualization instances such as a container, a virtual machine, a virtual private server, a virtual kernel, or another suitable virtualization instance.

The network 170 provides connections to the components of the system environment 100 through one or more sub-networks, which may include any combination of local area and/or wide area networks, using both wired and/or wireless communication systems. In one embodiment, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), JavaScript object notation (JSON), and structured query language (SQL). In some embodiments, some of the communication links of a network 170 may be encrypted using any suitable technique or techniques such as secure sockets layer (SSL), transport layer security (TLS), virtual private networks (VPNs), Internet Protocol security (IPsec), etc. The network 170 also includes links and packet-switching networks such as the Internet. In some embodiments, a data store belongs to part of the internal computing system of a server (e.g., the authorizer data store 165 may be part of the authorizer server 160). In such cases, the network 170 may be a local network that enables the server to communicate with the rest of the components.

### Example Server Components

FIG. 2 is a block diagram illustrating components of an online platform 110, in accordance with an embodiment. The online platform 110 includes a user profile management engine 205, an account management engine 210, a policy management engine 220, a category identification engine 225, a machine-learned model 240, a reward engine 245, a promotion and offer engine 250, item management engine 255, and basket history store 260. In some embodiments, the functions of various components may be distributed in a different manner than described below. Moreover, while each of the components in FIG. 2 may be described in a singular form, the components may present in plurality. The components may take the form of a combination of software and hardware, such as software (e.g., program code comprised of instructions) that is stored on memory and executable by a processing system (e.g., one or more processors).

The user profile management engine 205 stores and manages users of the online platform 110. The users may be donors, beneficiaries, other people who participate in crowd-sourcing events, users of wallets, or shoppers through applications or the marketplace. For example, the user profile management engine 205 may store profiles of users and events associated with the beneficiaries, such as events and plans that a beneficiary described to justify the launching of a crowd-sourcing event, spending history of the users, shopping favorites, purchase categories, possible product bundles, and offers. The online platform 110 may use one or more machine-learned models, such as large language models (e.g., any transformer-based language models), to identify the intents and key conditions associated with a crowd-sourcing event. The intents and conditions may also be set by the beneficiary and/or the donors manually based on the agreement between the beneficiary and the donors. The online platform 110 may store the policies that may be used to implement the intents and conditions.

The account management engine 210 creates and manages accounts including crowd-sourcing instances, user accounts, transaction accounts that are issued by the online platform 110, wallet accounts, and user cards. Users may register with the online platform 110. For example, transferees, who are beneficiaries of crowd-sourcing events, may sign up on a site operated by online platform 110 and specify the type and quantity of resources they need. Users can be shoppers or participants in crowd-sourcing events. Based on the nature of a crowd-sourcing event, the transferee may also specify what categories the transferee would like to use the resources. After the crowd-sourcing event begins or reaches a target, the online platform 110 may set up a new transaction account (e.g., a resource tracking account, a blockchain wallet, a virtual credit card) for the transferee or may transfer the resources to an existing transaction account. The transaction account may start as unfunded and the limit may grow as the crowd-sourcing event progresses. In some embodiments, the transaction account may start with a certain amount after the crowd-sourcing event reaches a target. In some embodiments, a user may add her own card and start the use of collected resources right away.

In some embodiments, the account management engine 210 may also maintain originator accounts. Originators may select the categories to donate or provide their resources. In some embodiments, the donation may be through a direct resource donation or through the donation of rewards of the originators' transaction accounts. For example, the resources in a crowd-sourcing event could be cash, coupons, reward points, or other type of fungible resources. Instead of donating direct resources to the beneficiary, the originators may originate the points of rewards in certain categories that may maximize the reward amount. The online platform 110 can check the originator's card and find the categories with the highest benefits. For example, wished categories of a beneficiary may line up with the card rewards of the originators. In some embodiments, the originators' cards may be operated by a third party. The online platform 110 may perform an API call (e.g., from NerdWallet) to get rewards for a particular card. The online platform 110 may provide a user interface that shows candidate beneficiaries whose wished categories in a crowd-sourcing event line up with the originator's optimal categories. From the results, the originators choose particular beneficiaries and choose an amount to donate. In some embodiments, the originator may also provide resources as a form of card purchase and the originator may accumulate rewards based on the donation amount.

A transaction account is associated with a person and may correspond to a card. For example, the online platform 110 may issue a virtual card to a beneficiary. The transaction account may be associated with spending limits and transaction policies that are based on the crowd-sourcing events and/or based on individual originator's conditions when the originator donated the resources. The account management engine 210 may create the card serial number, credentials, a unique card identifier, and other information needed for the generation of a transaction account and corresponding card. The account management engine 210 associates the information with the cardholder's identifier. The online platform 110 may associate the card account created with the identifier of the online platform 110 so that transactions related to the card will be forwarded to the online platform 110 for approval based on various policies. In some cases, the account management engine 210 may also order the production of a physical card that is issued under the online platform 110. The cards and transaction accounts created may associated with the transaction rules that are specified in one or more crowd-sourcing events.

The policy management engine 220 allows users (e.g., originators, and transferees) to specify rules for transactions. An account may be a transaction account such as a card account. A transaction policy may be a usage rule for one or more cards created by the online platform 110. The policies may be based on transaction categories, merchant categories, specific merchants, time limits, date limits, amount limits, and/or other suitable criteria. For example, in creating or editing a card based on conditions of a crowd-sourcing event, the online platform 110 may specify a date and time limit on the card. The user may also specify a transaction amount limit for each transaction. The transaction amount limit may be different from the card limit. The card limit specifies the total amount that a cardholder can spend for a period of time (e.g., monthly limit). The administrator may further specify a transaction amount limit for the maximum amount of spending for each transaction. The policies can also be based on transaction category, merchant category, and specific merchants that are pre-approved or denylisted for a specific card. The policy management engine 220 stores various policies associated with each card as part of the variables associated with the card. A policy may also be specific to an originator. For example, an originator may specify a restriction on a certain amount of funds that is donated to the beneficiary.

In some embodiments, the policy management engine 220 may use one or more machine-learned models to automatically identify a policy based on a description of the crowd-sourcing event. For example, a beneficiary may create a crowd-sourcing event and create a description of the purpose of the crowd-sourcing event. In various embodiments, the usage restrictions of the crowd-sourcing event may take different forms. For example, in some embodiments, the usage restrictions are rule-based such as using the type of rules discussed above. In some embodiments, the usage restrictions may also be enforced using fuzzy logic and/or a machine-learned model instead. For example, a user may not need to manually set restrictions on the usage. Instead, the description and transactions of the crowd-sourcing events are inputted into the machine-learned model, such as a large language model, and the model automatically digests the description and understands the purpose of the crowd-sourcing events. In turn, in each transaction of an attempted use of a resource by a user, the transaction payload may be inputted into the machine-learned model for the model to determine whether to approve the transaction.

The category identification engine 225 identifies whether a transaction belongs to a particular merchant category provided by the online platform 110. Example categories may include “Books and Newspapers,” “Car Rental,” “Clothing,” “Electronics,” “Entertainment,” etc. The use of a particular card may be restricted to one or more categories. The online platform 110 receives transaction data of a resource transfer and determines the category to which the transaction belongs. In one embodiment, the merchant categories provided by the online platform 110 may be based on merchant category codes (MCC). In some embodiments, in crowd-sourcing events, the policies may specify one or more categories that are authorized for the transaction accounts. The online platform 110 may use the MCC to enforce the categories. In some embodiments, the online platform 110 may also dynamically select the business with the appropriate MCC. Resources may be transferred to the selected entity, so that the originator's transaction account is charged with the right MCC.

One or more machine-learned models 240 may analyze stories and descriptions provided by a beneficiary in crowd-sourcing events to suggest or automatically determine the intents and conditions of the crowd-sourcing events, using various natural language processing (NLP) techniques. Based on the NLP techniques, a machine-learned model 240 may suggest to the originators or automatically generate one or more policies that are associated with a transaction account issued to the beneficiary based on the crowd-sourcing event. A machine-learned model 240 may also receive a payload of a transaction and determine whether the transaction satisfies the policies associated with the crowd-sourcing event. For example, a machine-learned model 240 may be rule-based and/or artificial intelligence-based. In a rule-based model, the machine-learned model 240 may review one or more parameters (e.g., MCC, transaction amount, date) of a transaction and determine whether the parameters satisfy a rule that represents a policy. In an artificial intelligence-based model, the machine-learned model 240 may convert the transaction into a feature vector and determine whether the transaction satisfies a policy based on training. The training may be performed using historical transactions that are known to be in compliance or in violation of a policy. In some embodiments, machine-learned models may be used to predict best-bundled offers for retailers, instant reward opportunities for consumers, and high-value partners for retailer markets. Locations, basket data, consumer spending history, credit card balances, best rewards in the marketplace, promotional offers and past offers, timing on past purchases, likelihood to purchase in the future, retailer SKUs, supply, and inventory may be used to train the machine-learned models. Training of the machine-learned model is further discussed below.

A reward engine 245 may track various transaction accounts, including third-party account types to identify additional rewards that may be awarded to users. The reward engine 245 may receive transaction data associated with transactions. The transaction data may include information related to resource transfer made by a user. The reward engine 245 may analyze the transaction data to identify eligible transactions for reward accrual based on predetermined criteria, including merchant category codes, transaction amounts, and designated reward categories. Additionally, the reward engine 245 may monitor and track the accumulation of rewards points or other forms of rewards associated with the eligible transactions. Furthermore, the reward engine may dynamically adjust reward accrual rates and redemption options based on user preferences, promotional offers, and changes in market conditions.

A promotion and offer engine 250 may receive and analyze transaction data from credit card transactions, identifying qualifying transactions based on predefined criteria such as transaction amounts, merchant categories, and user demographics. The promotion and offer engine 250 dynamically applies promotional offers, discounts, or rewards to eligible transactions in real-time, leveraging user-profiles and historical transaction data to personalize the offers. Additionally, the promotion and offer engine tracks the performance of promotional campaigns, measuring metrics such as redemption rates, user engagement, and return on investment. Moreover, the promotion and offer engine 250 facilitates the creation and management of targeted marketing campaigns, allowing issuers to tailor promotions to specific user segments and strategic objectives.

An item management engine 255 manages items that are selected by a user at checkout before approving using the resource in exchange for the items. In some embodiments, the item management engine 255 maintains a taxonomy data tree that classifies data instances representing the items into various categories. For example, each data instance may be associated with a specific unique identifier that represents the item. The unique identifier may take the form of stock keeping unit (SKU) or another suitable identifier. The taxonomy data tree may be built by a machine-learned model that classifies various items into different categories and each category may be associated with an intent. The category may be used to enforce usage restrictions of the fungible resources in a crowd-sourcing event. The machine-learned model may be trained to automatically assign an item to a category. In a transaction, the item management engine 255 may use the taxonomy data tree to determine the nature of the items selected in a browsing session of the transaction and determine whether the selection of the item is compliant with the usage restriction set forth in a crowd-sourcing event.

A basket history store 260 stores the history of transactions of users. The basket history store 260 may also store associated usage restrictions of the resources used in exchange for the items in the basket. In some embodiments, data entries stored in the basket history store 260 may be used to generate machine-learning training samples for training a machine-learned model that is used to automatically approve or reject transactions based on usage restrictions of a crowd-sourcing event.

### Example Process Flow

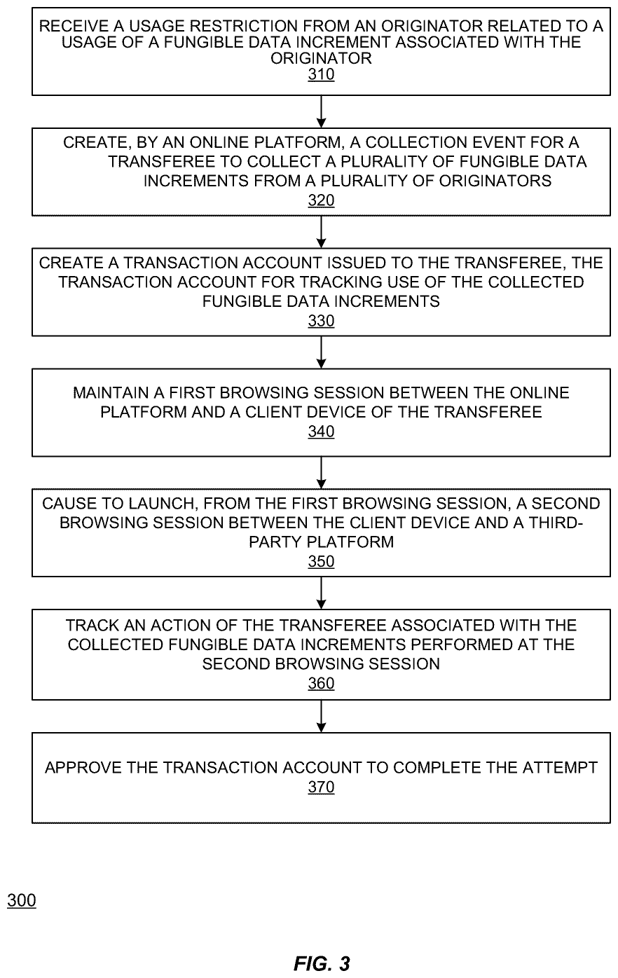

FIG. 3 is a flowchart depicting an example process 300 for enforcing usage restrictions in a crowd-sourcing event, according to some embodiments. In various embodiments, the process 300 includes different or additional steps than those described in conjunction with FIG. 3. Further, in some embodiments, the steps of the process 300 may be performed in different orders than the order described in conjunction with FIG. 3. The process 300 may be carried out by online platform 110 in various embodiments. While the process 300 is described as using the online platform 110, in some embodiments the steps of the process 300 may be performed by any suitable online system.

In some embodiments, the online platform 110 receives 310 a usage restriction from an originator related to the usage of a fungible data increment associated with the originator. For example, the originator may be a donor in a crowd-sourcing event and may specify how the resources donated by the originator can be subject to one or more usage restrictions. The usage restrictions may be based on rules that are described in policy management engine 220 and/or based on intents that can be interpreted by a machine-learned model. The usage restriction may be initiated by the originator or may be received as approval from the originator. For example, an originator may participate in a crowd-sourcing event that has one or more usage restrictions specified by the beneficiary. By agreeing to participate in the crowd-sourcing event and transferring a resource to the event, the originator may provide approval to the usage restriction associated with the crowd-sourcing event.

In some embodiments, the online platform 110 creates 320 a collection event for a transferee to collect a plurality of fungible data increments from a plurality of originators. A crowd-sourcing event may be an example of a collection event, which collects resources such as fungible data increments from various originators who want to participate in the collection event. The transferee may be referred to as a beneficiary. The collected fungible data increments (e.g., resources) in the collection event are subject to the usage restriction. There can be one or more usage restrictions. The usage restrictions may be determined by the transferee for the purpose of attracting more originators and/or may be initiated from originators. In some embodiments, an originator may approve usage restrictions that are specified in a collection event. By way of example, the online platform 110 may receive, from the transferee, an association between the usage restriction and the collection event.

The online platform 110 may receive a donation from the originator to donate the fungible data increment to the collection event. In turn, the online platform 110 may apply the usage restriction to future usages of the fungible data increment. In some embodiments, an originator may also set forth a restriction on the usage of the fungible data increment donated from the originator.

In some embodiments, the usage restrictions may be generated automatically by a machine-learned model, such as a large language model, based on the description of the intent or background of the collection event. For example, in a crowd-sourcing event, the transferee beneficiary may describe the intent of why the beneficiary is asking for a donation of resources. The online platform 110 may allow the transferee to describe a story of the collection event in natural language. The online platform 110 may apply a transformer machine-learned model to identify one or more usage restrictions based on the story in natural language. The online platform 110 may in turn generate the usage restriction associated with the collection event using the output of the machine-learned model.

Responsive to the collection event collecting the plurality of fungible data increments for the transferee, the online platform 110 creates 330 a transaction account issued to the transferee. The transaction account may be used for tracking the use of the collected fungible data increments to make sure the use is compliant with the usage restriction. In some embodiments, the usage restriction may be built in with the transaction account. For example, the transaction account may be associated with a category of usage or a category of third party with which the transferee may use the transaction account to interact. In some embodiments, the online platform 110 may associate the transaction account to a third-party named entity category, such as a merchant category or one or more MCC codes. The online platform 110 may restrict transactions of the transaction account to the third-party named entity category. The third-party named entity category may be associated with the usage restriction. For example, the usage restriction may specify a type of activity (e.g., education) that the transferee may spend the fungible data increments. The online platform 110 may impact a category restriction that limits the third parties with which the transaction account is allowed to interact to only third parties that are in the education category.

In various embodiments, the transaction account issued to the transferee may take different forms. For example, the transaction account may be a digital account that includes a ledger for keeping track of the balance of the fungible data increments. If the transferee spends a quantity of the resource, the ledger reduces the fungible data increment recorded in the account. If the transferee receives additional resources from the crowd-sourcing event, the ledger increases the fungible data increment recorded in the account. In some embodiments, the collection event is a crowd-sourcing event. The resources collected for the transferee may originate from different originators. In some embodiments, since the resources may be fungible, the total of the fungible data increments may be indistinguishable with respect to the originators from the perspective of the transferee.

In some embodiments, the transaction account may be platform agnostic. In some embodiments, the transferee may use the transaction account on any platform, including both digital and physical platforms. The transaction account may include a unique identifier and a routing serial that indicates how transaction payloads should be routed. In some embodiments, in an attempt to use the transaction account through a transaction terminal 140, the transaction terminal 140 may transmit a transaction payload to the online platform 110 for the approval of the transaction. Hence, even though in some cases the transaction account may be platform agnostic, the online platform 110 may retain some control in approving or denying a transaction. However, in some embodiments, the format and information included in the transaction payload may be standardized or may be determined by the transaction terminal 140. The information in the transaction payload may be limited and may not be detailed enough for the online platform 110 to determine whether a usage restriction, which can have a high degree of variation, is applicable. In some embodiments, the online platform 110 may use additional information collected from another source (e.g., a third-party platform 160) to determine the nature of the transaction and whether the transaction is compliant with the usage restriction.

In some embodiments, the creation of a transaction account may be based on the amount of collected resources and the user's authentication and identity verification. For example, if the collected resource is below a predetermined threshold in a crowd-sourcing event, the online platform 110 may issue a transaction account to the transferee without further verification. In some embodiments, after the collected resource is above the threshold in a crowd-sourcing event, the online platform 110 may impose an authentication and identity verification requirement, such as know-your-customer (KYC) requirement, for the transferee to continue to use the transaction account. In some embodiments, the online platform 110 may create a recission time for the originator to cancel the donation. The recission time may be based on whether the transferee's identity is verified. A short recission time window may be allowed if the transferee's identity is verified.

In some embodiments, the online platform 110 maintains 340 as a first browsing session between the online platform and a client device of the transferee. For example, the first browsing session may be a session for the transferee to manage the collection event, adjust the user profile, and select a list of third-party platforms 160 that are in cooperation with the online platform 110. For example, the online platform 110 may provide, in the first browsing session, a plurality of options of third-party platforms 160 for a selection of the transferee. The online platform 110 may receive an interaction from the transferee selecting the third-party platform 160. Responsive to the selection, the online platform 110 may cause a second browsing session to launch. In some embodiments, the online platform 110 may maintain a marketplace that allows third-party platforms 160 to provide items on the online platform 110. For example, in some embodiments, the transferee may directly browse the online platform 110 to use the fungible data increments. In the marketplace, the online platform 110 may directly enforce one or more usage restrictions.

In some embodiments, the online platform 110 may cause 350 to launch, from the first browsing session, a second browsing session between the client device and a third-party platform 160. In some embodiments, the second browsing session may be directly between the client device and the third-party platform 160. In some embodiments, the online platform 110 may continue to provide an association between the user in the first browsing session and the second browsing session so that the usage of fungible data increments may be tracked. By way of example, the online platform 110 may create a session identifier for the online platform 110 to track the second browsing session. The session identifier may take the form of an identifier in the uniform resource locator (URL) in launching the second browsing session, a session-specific identifier, a cookie, or another suitable identifier. For example, the online platform 110 may generate a deeplink that directs the transferee to the third-party platform 160 and at the same time inform, such as through a specific string in the deeplink, the third-party platform 160 that the visitor (transferee) is associated with an identifier. The URL may contain a domain name of the third-party platform and a session identifier. The URL may launch the second browsing session.

In some embodiments, the online platform 110 may use cookies, which are small data files stored on user devices to record information about browsing activities. Upon visiting an online platform 110 in the first browsing session, cookies may be deposited on the transferee's browser. These cookies are then utilized during subsequent browsing sessions on other websites within the same network or affiliation, enabling cross-site tracking of the transferee's usage of fungible resources. Alternatively or additionally, the online platform 110 may employ browser fingerprinting techniques to gather unique information about user devices and configurations. This information, including operating system details, screen resolution, installed fonts, and plugins, forms a unique fingerprint that can be used to identify users across different browsing sessions. By analyzing browser fingerprints, the system can correlate transferee activities and behaviors between various websites, even in the absence of cookies. Alternatively or additionally, the system incorporates tracking scripts and third-party services to enhance cross-site tracking capabilities. These scripts, embedded within the code of websites, collect and transmit data to external servers. Through these channels, user data collected during browsing sessions on one website can be linked to subsequent sessions on other websites, facilitating comprehensive user profiling and behavior analysis.

Informing the third-party platform 160 that the visitor is associated with the online platform 110, this causes the third-party platform 160 to provide additional information and data to be forwarded to the online platform 110.

In some embodiments, the online platform 110 tracks 360 an action of the transferee associated with the collected fungible data increments performed at the second browsing session. The online platform 110 may receive, from the third-party platform 160, a data payload that includes information indicating an attempt by the transferee to further transfer at least a portion of the collected fungible data increments to the third-party platform 160. In some embodiments, this data payload may be received in addition to a transaction payload transmitted from the transaction terminal 140. For example, the transaction payload from the transaction terminal 140 may be a request for the online platform 110 to approve or deny a transaction. Having an association between the transferee and the visitor in step 350, the third-party platform 160 may transmit a data payload that includes additional information compared to the transaction payload. For example, the data payload may include detailed itemized usage or even item identifiers in an order. In some embodiments, the online platform 110 may receive, in the data payload, a list of items selected by the transferee in the second browsing session. The online platform 110 applies the usage restriction to the information to determine whether the attempt violates the usage restriction. The data payload used by the online platform 110 to determine usage restriction may include the payload from the third-party platform 160 and the payload from the transaction terminal 140.

In some embodiments, in determining whether an attempted transaction is compliant with the usage restriction, the online platform 110 may use a machine-learned model. The online platform 110 may input at least a portion of the data payload to a machine-learned model. The online platform 110 receives an output of the machine-learned model that analyzes the portion of the data payload (including the payload from the third-party platform 160 and the payload from the transaction terminal 140) based on the usage restriction. For example, the portion of the data payload may be a list of items selected by the transferee and/or MCC codes and other transaction data. The online platform 110 determines whether the attempt violates the usage restriction based on the output.

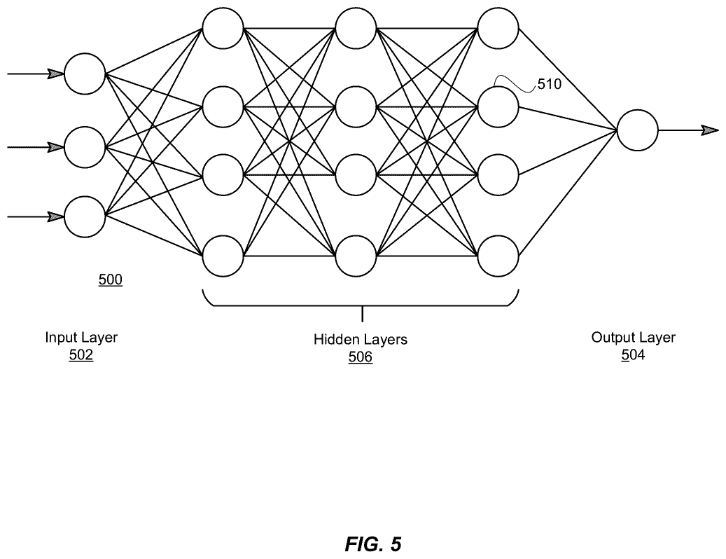

The training of the machine-learned model may include iteratively adjusting the parameters of the machine-learned model using training samples. In some embodiments, the online platform 110 receives a plurality of training samples. Each training sample may include (1) a label of whether a historical transaction is compliant with a historical usage restriction and (2) a feature vector of the historical transactions. The feature vector may include user characteristics, item characteristics, amount, date, contextual data, and other metadata. The online platform 110 may initiate a plurality of parameters associated with the machine-learned model. The online platform 110 may generate, in a forward propagation using feature vectors of the training samples, a plurality of predictions of compliance. The online platform 110 may compare the plurality of predictions of compliance to labels of the training samples. The online platform 110 may backpropagate comparisons between the plurality of predictions and the labels to the parameters to adjust the values of the parameters. Further details of training and usage of machine-learned models are discussed in association with FIG. 5.

In some embodiments, responsive to determining that the attempt is in compliance with the usage restriction, the online platform 110 approves 370 of the transaction account to complete the attempt. If the online platform 110 determines that the attempt violates a usage restriction, the online platform 110 may deny the attempted transaction and report a potential violation. In some embodiments, the online platform 110 may communicate to the transaction terminal 140 to approve or deny the transaction. In some embodiments, the approval or denial of a transaction may be associated with a code identifying the reason. In some embodiments, the online platform 110 may use a machine-learned model such as a large language model to generate a reason for the denial.

In some embodiments, the online platform 110 may generate an analytics report to the originator on the usage of the fungible data increment. In some embodiments, whether the transactions are approved or denied, the online platform 110 may include those transactions in the analytics report. The online platform 110 may receive a report (e.g., a response) from the originator on a potential violation of the usage restriction. Responsive to the report, the online platform 110 may adjust the usage privilege of the transaction account.

For example, if multiple originators report potential violations and the online platform 110 determines that the number of creditable violations exceeds a threshold, the online platform 110 may temporarily or permanently restrict the use of the transaction account.

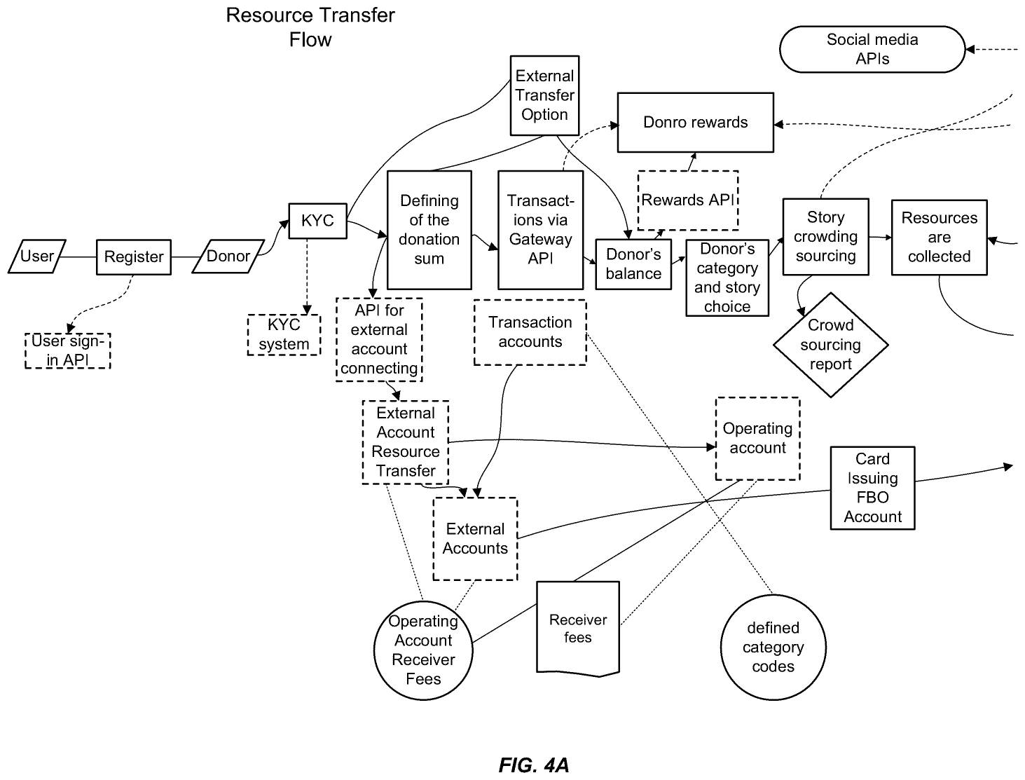

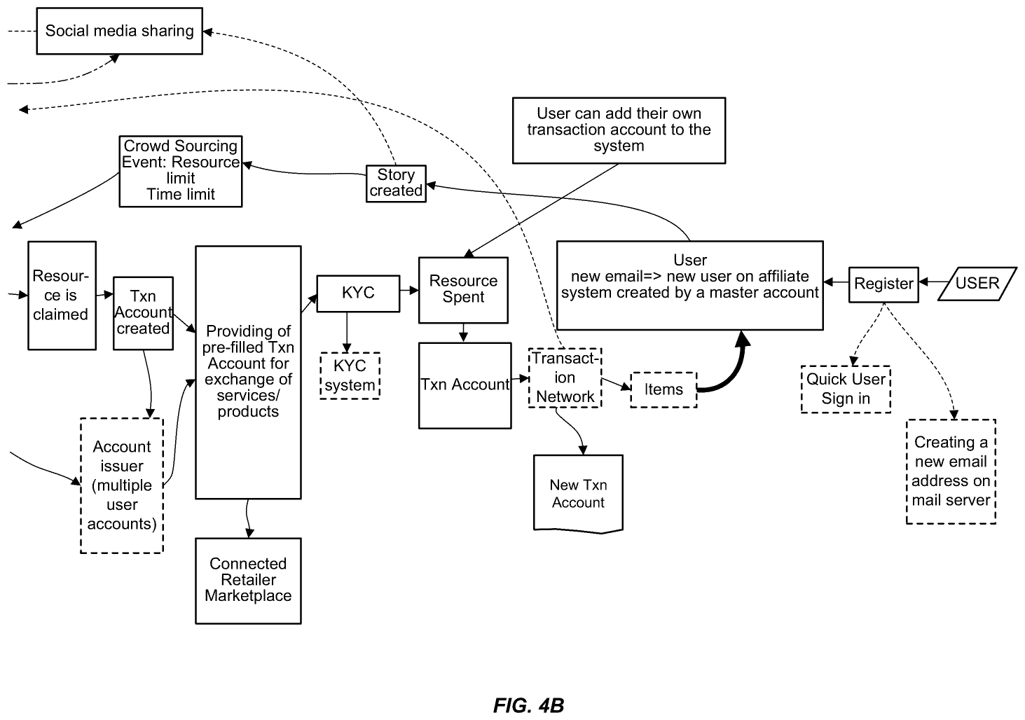

FIGS. 4A and 4B are examples of block diagrams describing a process of a crowding sourcing event and enforcing the policy after a transaction account is issued to a beneficiary, in accordance with some embodiments.

In FIG. 4A, a user may register with the online platform 110 through a suitable authentication mechanism to become an originator. The identity of the user may be verified by any suitable know-your-customer (KYC) system. Upon registration, the user may link various accounts to the online platform 110, such as the user's bank account that is connected through any authentication system and credit card accounts. The connections allow an originator to provide fungible resources to a crowd-sourcing event through various ways, such as a direct deposit from a bank account through ACH transfer and credit card payments. The originator may also provide fungible resources as a form of card spending. In turn, the originator may accumulate rewards such as cashback rewards from the donation. The rewards may be sent through an API. The online platform 110 keeps track of the originator's balance. The originator may choose categories and stories that the originator prefers to donate. In some embodiments, the online platform 110 may also monitor the philanthropist level of the originator and may maintain different tiers of transaction fees from the originator. The originator may provide fungible resource donations that are specific to an MCC code. In some embodiments, the system may include different entities (e.g., 11 entities with defined category codes). Example category codes may include hotels, airfare, gasoline, rideshare, health, home improvement, advertising, business, groceries, restaurant, shipping, streaming, charity, etc.

Referring to FIG. 4B, another user may register with the online platform 110 through a suitable authentication mechanism to become a transferee beneficiary. A transferee may create a crowd-sourcing event to become a beneficiary of the crowd-sourcing event. The transferee may be associated with an account of online platform 110 that maintains a reward level for the transferee. The transferee may create a story that is fundable and is associated with a resource amount limit and a time limit. Various originators may review the story or be automatically matched to the story and may decide to donate resources to the story. The story and funding may be shared through social media, such as through the APIs of various social media platforms. The online platform 110 creates a transaction account for the transferee after the donated resource is claimed. The transaction account may be subject to one or more policies that are specified by the crowd-sourcing story and/or an individual originator. The transferee may use the transaction account to use the fungible resources based on the policy restriction. Rewards may be generated, and fees may be deducted from the transaction account.

In a marketplace, for a transferee at checkout, various transactions may be classified by SKUs or item/service categories. The system may segment the purchases and select the best transaction accounts that reward the most. The transactions may be split and various APIs to third-party platforms 160 are called and tokens are sent to the third-party platforms 160. For example, the user basket may be segmented through checkout, and different tokens are sent to different third-party platforms 160 to maximize rewards.

In some embodiments, the flow of resources between an originator and a beneficiary (transferee) may be bi-directional. The initial donator of the resources may be transferred from an originator to a transferee. Fees may be deducted from the overall balance. As the originator spends by funding a story, an award of a portion of the donation may be generated for the originator. The transferee may receive the resources through a transaction account maintained by the online platform 110. In some embodiments, the usage of the transaction account may generate rewards. The rewards may be awarded to the transferee or may go back to the originator so that the originator may receive resources.

In some embodiments, category restriction may be imposed on a transaction account that is implemented in a marketplace of online platform 110 with examples of categories, in accordance with some embodiments. The account may be used in one or more categories. In some embodiments, an originator may specify a category that is different from another originator. In some embodiments, there can be an unlimited amount of specific merchant categories in a marketplace of the online platform 110. In some embodiments, each category may be completely separate and has its own set of third-party platforms 160 through integration with the online platform 110.

### Example Machine-Learned Model

In some embodiments, an AI-driven dual-scoring system for donations is disclosed. The approach maximizes efficiency and impact. The machine-learned model uses a dual-scoring system.

The first scoring machine-learned model may evaluate originators' willingness to give by considering various parameters and indicators such as giving history, interests, and donation preferences. The second scoring machine-learned model score evaluates the transferee's needs by considering parameters such as the nature of the crowd-sourced event or need, urgency, and feasibility. By creating these two distinct scores, the online platform 110 can better understand and cater to the needs of both originators and transferees in need. To make these scores as informative as possible, numerous parameters and indicators are considered. For the first scoring machine-learned model, a feature vector may include parameters that cover various aspects such as donation history, award utilization, social media sharing, responsiveness to donation campaigns, and more. For the second scoring machine-learned model, a feature vector may include parameters that cover factors such as financial need, community involvement, the urgency of the request, and the potential impact of the assistance provided.

In some embodiments, the online platform 110 may maximize the scores using the two machine-learned models. A machine-learned system may have the potential to optimize both scores, enabling data-driven decisions that improve the impact of donations. In some embodiments, the online platform 110 may include multiple machine-learned components. For example, the online platform 110 may include a planner, an engager, and an analyzer. The planner may generate hypotheses to test based on the data collected from both scores. The engager may interact with originators and transferee, providing them with relevant information and updates, and suggesting matches. The analyzer may collect the data from the engager system and measure scores generated from the first scoring machine-learned model and the second scoring machine-learned model. The analyzer may in turn provide feedback to the planner to create new hypotheses and improve the system continuously.

Using these components, the online platform 110 may continuously optimize the donation system, providing the best matches between originators and transferees, and maximizing the system's impact.

The following steps may be implemented by the online platform 110 in applying the AI. Data Collection: Gather historical and real-time data on user behaviors, preferences, interactions, and demographic information. Data Preprocessing: Clean and preprocess the data to ensure accuracy, removing any discrepancies or outliers that may skew the analysis. Feature Selection: Identify the most relevant features from the collected data, assigning appropriate weights based on their importance and relevance to each score. Model Development: Develop and train machine-learned models to predict first-scoring machine-learned model and second-scoring machine-learned model scores using the selected features. Model Evaluation: Test the models on a separate dataset to evaluate their performance and ensure their accuracy in predicting the scores. Implementation: Integrate the AI models into the donation platform, enabling the system to continuously update and refine the first-scoring machine-learned model and second-scoring machine-learned model scores based on new data. Optimization: Analyze the AI-driven predictions to identify opportunities for improvement, such as providing personalized recommendations or incentives for originators, or matching beneficiaries with the most suitable originators.

By implementing the AI-driven first-scoring machine-learned model and second-scoring machine-learned model scores, the system can optimize its donation system, efficiently connecting originators with individuals in need. With the power of AI technologies, the system can optimize both scores simultaneously, resulting in a more efficient and effective donation system that caters to the needs of both originators and individuals in need.

In various embodiments, a wide variety of machine-learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN), and long short-term memory networks (LSTM), may also be used. For example, the identification of intents and conditions in a story of a crowd-sourcing event may be performed by a machine-learned model 240 and the automatic generation of transaction policies that are maintained by an online platform 110 may also be performed by a machine-learned model 240. Other processes may apply one or more machine learning and deep learning techniques.

In various embodiments, the training techniques for a machine-learned model may be supervised, semi-supervised, or unsupervised. In supervised learning, the machine-learned models may be trained with a set of training samples that are labeled. For example, for a machine-learned model trained to identify intents and conditions, the training samples may be historical crowd-sourcing events that include the descriptions of those events and associated stories. The labels for each training sample may be binary or multi-class. In training a machine-learned model for intent identification, the training labels may include a positive label that indicates the presence of a particular condition and a negative label that indicates the lack of a particular condition. In some embodiments, the training labels may also be multi-class such as the past known intents and conditions of the historical crowd-sourcing events.

By way of example, the training set may include multiple past records of crowd-sourcing events with known policies that are imposed in those events. Each training sample in the training set may correspond to a past and the corresponding outcome may serve as the label for the sample. A training sample may be represented as a feature vector that includes multiple dimensions. Each dimension may include data of a feature, which may be a quantized value of an attribute that describes the past record. For example, in a machine-learned model that is used to identify intents and conditions, the features in a feature vector may include the text in the story description encoded by embedding vectors, time, funding amount, originator identifiers, categories authorized or restricted, etc. In various embodiments, certain pre-processing techniques may be used to normalize the values in different dimensions of the feature vector.

In some embodiments, the feature vectors used in a machine-learned model may include the following features. For example, the features may include transaction history such as the record of a user's past transactions with a company. For transaction history, indicators may include the number of transactions, the total amount spent, types of products purchased, time since the last purchase, and recurring purchases (e.g., subscription renewals). The feature may also include user engagement, such as the degree to which a user interacts with the company's online presence, such as the website, app, and social media channels. For user engagement, indicators may include the number of website visits, time spent on the website, number of app sessions, click-through rates (CTR) on emails and ads, and social media likes, comments, and shares.

In some embodiments, the features may also include sentiment analysis, such as the assessment of a user's emotional response to a brand or its products, often derived from their reviews, social media posts, or support interactions. The indicators may include positive, neutral, or negative sentiment in reviews, emojis used in social media posts, sentiment expressed in support interactions, net promoter score (NPS), and text analysis of open-ended survey responses.

In some embodiments, the features may also include loyalty points and rewards, such as the incentives offered to users as part of a loyalty program, which can be earned through various actions (e.g., purchases, referrals) and redeemed for discounts or exclusive offers. The indicators may include the number of points earned, the number of points redeemed, the number of loyalty program tiers achieved, the value of rewards redeemed, and participation in exclusive loyalty program events or offers.

In some embodiments, the features may also include personalization, such as the customization of a user's experience with the company based on their preferences, behavior, and demographic information. The indicators may include click-through rates on personalized emails and ads, conversion rates for personalized product recommendations, personalized content engagement (e.g., blog posts, videos), satisfaction ratings for personalized experiences, and uptake of personalized offers or promotions.

In some embodiments, the features may also include social media influence, such as the impact a user has on their followers or connections on social media platforms, which can potentially influence their transaction decisions. The indicators may include number of followers or connections, engagement rates (e.g., likes, comments, shares), influencer status or verified accounts, frequency of brand-related posts or mentions, reach of social media posts (impressions).

In some embodiments, the features may also include task/challenge completion, such as the user's engagement with gamification elements, such as completing tasks or challenges, to earn points or rewards. The indicators may include number of tasks or challenges completed, points earned from task/challenge completion, completion rate of available tasks/challenges, participation in time-limited or exclusive challenges, ranking, or leaderboard position.

In some embodiments, the features may also include discount sensitivity, such as the extent to which a user's purchase behavior is influenced by discounts, promotions, or special offers. The indicators may include the frequency of discounted purchases, the average discount amount on purchases, the redemption rate of promotional codes or offers, uptake of limited-time deals or flash sales, and the price elasticity of demand for products.

In some embodiments, the features may also include product category preferences, such as the user's inclination towards specific product categories offered by the company (e.g., laptops, desktops, accessories). The indicators may include the frequency of purchases within each category, the amount spent within each category, the share of wallet within each category, product return rates within each category, and engagement with category-specific content (e.g., blog posts, and videos).

In various embodiments, the features may include transaction history, user engagement, sentiment analysis, loyalty points and rewards, personalization, social media influence, task/challenge completion, discount sensitivity, product category preferences, product type preferences, recency, frequency, monetary (RFM) analysis, product affinity, seasonality, user demographics, user life stage, customer lifetime value (CLV), user service interactions, email or push notification open rates, website or app behavior, promotional responsiveness, preferred operating system, technical proficiency, interest in upgrades and new technologies, computer usage (e.g., gaming, work, casual), warranty and service plan purchases, referral activity (inviting friends to the platform), accessory purchasing behavior, hardware customization preferences, software and app preferences, financing options utilization, responsiveness to personalized recommendations, trade-in or recycling program participation, engagement with educational content (e.g., tutorials, guides), participation in community forums, interest in sustainability initiatives, subscription to company newsletter, interest in exclusive promotions and offers, cross-product interests (e.g., laptops, desktops, peripherals), engagement with company events and webinars, interest in business solutions and services, preferred payment methods, interest in certified refurbished products, device security awareness, preference for online vs. in-store purchases, use of company support services, brand affinity, cross-industry interests (e.g., gaming, design, business), engagement with company's social responsibility initiatives, platform loyalty, and interest in extended warranty and support options.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine-learned model may be associated with an objective function, which generates a metric value that describes the objective goal of the training process. The training process may intend to reduce the error rate of the model in generating predictions. In such a case, the objective function may monitor the error rate of the machine-learned model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in identifying intents and conditions, the objective function may correspond to predicted intents versus actual intents recorded in the historical training samples. In various embodiments, the error rate may be measured as cross-entropy loss, L1 loss (e.g., the sum of absolute differences between the predicted values and the actual value), and L2 loss (e.g., the sum of squared distances).

Referring to FIG. 5, the structure of an example neural network is illustrated, in accordance with some embodiments. The neural network 500 may receive an input and generate an output. The input may be the feature vector of a training sample in the training process and the feature vector of an actual case when the neural network is making an inference. The output may be the prediction, classification, or another determination performed by the neural network. The neural network 500 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layers and a pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 500 may vary in different embodiments. In various embodiments, a neural network 500 includes one or more layers 502, 504, and 506, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine-learned model may include certain layers, nodes 510, kernels, and/or coefficients. Training of a neural network, such as the NN 500, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine-learned model may include an iterative process that includes iterations of making determinations, monitoring the performance of the machine-learned model using the objective function, and backpropagation to adjust the weights (e.g., weights, kernel values, coefficients) in various nodes 510. For example, a computing device may receive a training set that includes historical crowd-sourcing events. Each training sample in the training set may be assigned with labels indicating intents and conditions associated with the historical crowd-sourcing events. The computing device, in forward propagation, may use the machine-learned model to generate predicted intents and conditions. The computing device may compare the predicted intents and conditions with the labels of the training sample. The computing device may adjust, in a backpropagation, the weights of the machine-learned model based on the comparison. The computing device backpropagates one or more error terms obtained from one or more loss functions to update a set of parameters of the machine-learned model. The backpropagation may be performed through the machine-learned model and one or more of the error terms based on a difference between a label in the training sample and the generated predicted value by the machine-learned model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tan h), and rectified linear unit functions (ReLU). After input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine-learned model has converged) or after a predetermined number of rounds for a particular set of training samples. The trained machine-learned model can be used for identifying intents and conditions and generating policies for crowd-sourcing events, or for performing another suitable task for which the model is trained. Additional training samples may be continuously generated as the online platform 110 continues to operate and additional crowd-sourcing events are created. The model may be iteratively trained and re-trained using the additional training samples.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g., method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter that can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issued on an application based hereon. Accordingly, the disclosure of the embodiments is intended to be illustrative, but not limited, of the scope of the patent rights.

1. A computer-implemented method, comprising:
receiving a usage restriction from an originator related to a usage of a fungible data increment associated with the originator;
creating, by an online platform, a collection event for a transferee to collect a plurality of fungible data increments from a plurality of originators, wherein collected fungible data increments in the collection event are subject to the usage restriction;
responsive to the collection event collecting the plurality of fungible data increments for the transferee, creating a transaction account issued to the transferee, the transaction account for tracking use of the collected fungible data increments;
maintaining a first browsing session between the online platform and a client device of the transferee;
causing to launch, from the first browsing session, a second browsing session between the client device and a third-party platform;
tracking an action of the transferee associated with the collected fungible data increments performed at the second browsing session, wherein tracking the action of the transferee comprises:
receiving, from the third-party platform, a data payload comprising information indicating an attempt by the transferee to further transfer at least a portion of the collected fungible data increments to the third-party platform; and
applying the usage restriction to the information to determine whether the attempt violates the usage restriction; and
responsive to determining that the attempt is compliant with the usage restriction, approving the transaction account to complete the attempt.

2. The computer-implemented method of claim 1, wherein creating the collection event for the transferee comprises:
allowing the transferee to describe a story of the collection event in natural language;
applying a transformer machine-learned model to identify one or more usage restrictions based on the story in natural language; and
generating the usage restriction associated with the collection event.

3. The computer-implemented method of claim 1, wherein receiving the usage restriction from the originator related to the usage of the fungible data increment associated with the originator comprises:
receiving, from the transferee, an association between the usage restriction and the collection event;
receiving a donation from the originator to donate the fungible data increment to the collection event; and
applying the usage restriction to future usages of the fungible data increment.

4. The computer-implemented method of claim 1, wherein creating a transaction account issued to the transferee comprises:
associating the transaction account to a third-party named entity category; and
restricting transactions of the transaction account to the third-party named entity category, wherein the third-party named entity category is associated with the usage restriction.

5. The computer-implemented method of claim 1, wherein maintaining the first browsing session between the online platform and the client device of the transferee comprises:
providing, in the first browsing session, a plurality of options of third-party platforms for a selection of the transferee;
receiving the selection from the transferee selecting the third-party platform; and
responsive to the selection, causing the second browsing session to launch.

6. The computer-implemented method of claim 1, wherein causing to launch the second browsing session between the client device and the third-party platform comprises:
creating a session identifier for the online platform to track the second browsing session; and
generating a uniform resource locator that contains a domain name of the third-party platform and the session identifier, wherein the uniform resource locator launches the second browsing session.

7. The computer-implemented method of claim 1, wherein tracking the action of the transferee further comprises:
receiving, in the data payload, a list of items selected by the transferee in the second browsing session; and
applying the usage restriction to the list of items to determine whether the attempt violates the usage restriction.

8. The computer-implemented method of claim 1, wherein applying the usage restriction to the information to determine whether the attempt violates the usage restriction comprises:
inputting at least a portion of the data payload to a machine-learned model;
receiving an output of the machine-learned model that analyzes the portion of the data payload based on the usage restriction; and
determining whether the attempt violates the usage restriction based on the output.

9. The computer-implemented method of claim 8, wherein training of the machine-learned model comprises:
receiving a plurality of training samples, each training sample comprising (1) a label of whether a historical transaction is compliant with a historical usage restriction and (2) a feature vector of the historical transactions;
initiating a plurality of parameters associated with the machine-learned model;
generating, in a forward propagation using feature vectors of the training samples, a plurality of predictions of compliance;
comparing the plurality of predictions of compliance to labels of the training samples; and
backpropagating comparisons between the plurality of predictions and the labels to the parameters to adjust values of the parameters.

10. The computer-implemented method of claim 1, further comprising:
generating an analytics report to the originator on the usage of the fungible data increment;
receiving a report from the originator on a potential violation of the usage restriction; and
responsive to the report, adjusting a usage privilege of the transaction account.

11. A non-transitory computer-readable medium configured to store code comprising instructions, wherein the instructions, when executed by one or more processors, cause the one or more processors to:
receive a usage restriction from an originator related to a usage of a fungible data increment associated with the originator;
create, by an online platform, a collection event for a transferee to collect a plurality of fungible data increments from a plurality of originators, wherein collected fungible data increments in the collection event are subject to the usage restriction;
responsive to the collection event collecting the plurality of fungible data increments for the transferee, create a transaction account issued to the transferee, the transaction account for tracking use of the collected fungible data increments;
maintain a first browsing session between the online platform and a client device of the transferee;
cause to launch, from the first browsing session, a second browsing session between the client device and a third-party platform;
track an action of the transferee associated with the collected fungible data increments performed at the second browsing session, wherein the instructions to track the action of the transferee comprise instructions to:
receive, from the third-party platform, a data payload comprising information indicating an attempt by the transferee to further transfer at least a portion of the collected fungible data increments to the third-party platform; and
apply the usage restriction to the information to determine whether the attempt violates the usage restriction; and
responsive to determining that the attempt is compliant with the usage restriction, approve the transaction account to complete the attempt.

12. The non-transitory computer-readable medium of claim 11, wherein the instructions to create the collection event for the transferee comprise instructions to:
allow the transferee to describe a story of the collection event in natural language;
apply a transformer machine-learned model to identify one or more usage restrictions based on the story in natural language; and
generate the usage restriction associated with the collection event.

13. The non-transitory computer-readable medium of claim 11, wherein the instructions to receive the usage restriction from the originator related to the usage of the fungible data increment associated with the originator comprise instructions to:
receive, from the transferee, an association between the usage restriction and the collection event;
receive a donation from the originator to donate the fungible data increment to the collection event; and
apply the usage restriction to future usages of the fungible data increment.

14. The non-transitory computer-readable medium of claim 11, wherein the instructions to create a transaction account issued to the transferee comprise instructions to:
associate the transaction account to a third-party named entity category; and
restrict transactions of the transaction account to the third-party named entity category, wherein the third-party named entity category is associated with the usage restriction.

15. The non-transitory computer-readable medium of claim 11, wherein the instructions to maintain the first browsing session between the online platform and the client device of the transferee comprise instructions to:
provide, in the first browsing session, a plurality of options of third-party platforms for a selection of the transferee;
receive the selection from the transferee selecting the third-party platform; and
responsive to the selection, cause the second browsing session to launch.

16. The non-transitory computer-readable medium of claim 11, wherein the instructions to cause to launch the second browsing session between the client device and the third-party platform comprise instructions to:
create a session identifier for the online platform to track the second browsing session; and
generate a uniform resource locator that contains a domain name of the third-party platform and the session identifier, wherein the uniform resource locator launches the second browsing session.

17. The non-transitory computer-readable medium of claim 11, wherein the instructions to track the action of the transferee further comprise instructions to:
receive, in the data payload, a list of items selected by the transferee in the second browsing session; and
apply the usage restriction to the list of items to determine whether the attempt violates the usage restriction.

18. The non-transitory computer-readable medium of claim 11, wherein the instructions to apply the usage restriction to the information to determine whether the attempt violates the usage restriction comprise instructions to:
input at least a portion of the data payload to a machine-learned model;
receive an output of the machine-learned model that analyzes the portion of the data payload based on the usage restriction; and
determine whether the attempt violates the usage restriction based on the output.

19. The non-transitory computer-readable medium of claim 18, wherein instructions to train the machine-learned model comprises instructions to:
receive a plurality of training samples, each training sample comprising (1) a label of whether a historical transaction is compliant with a historical usage restriction and (2) a feature vector of the historical transactions;
initiate a plurality of parameters associated with the machine-learned model;
generate, in a forward propagation using feature vectors of the training samples, a plurality of predictions of compliance;
compare the plurality of predictions of compliance to labels of the training samples; and
backpropagate comparisons between the plurality of predictions and the labels to the parameters to adjust values of the parameters.

20. A system comprising:
one or more processors; and
memory configured to store code comprising instructions, wherein the instructions, when executed by the one or more processors, cause the one or more processors to:
receive a usage restriction from an originator related to a usage of a fungible data increment associated with the originator;
create, by an online platform, a collection event for a transferee to collect a plurality of fungible data increments from a plurality of originators, wherein collected fungible data increments in the collection event are subject to the usage restriction;
responsive to the collection event collecting the plurality of fungible data increments for the transferee, create a transaction account issued to the transferee, the transaction account for tracking use of the collected fungible data increments;
maintain a first browsing session between the online platform and a client device of the transferee;
cause to launch, from the first browsing session, a second browsing session between the client device and a third-party platform;
track an action of the transferee associated with the collected fungible data increments performed at the second browsing session, wherein
tracking the action of the transferee comprise instructions to:
receive, from the third-party platform, a data payload comprising information indicating an attempt by the transferee to further transfer at least a portion of the collected fungible data increments to the third-party platform; and
apply the usage restriction to the information to determine whether the attempt violates the usage restriction; and
responsive to determining that the attempt is compliant with the usage restriction, approve the transaction account to complete the attempt.
